(19) United States
(12) Patent Application Publication
(10) Pub. No.: US 2014/0150035 A1
(43) Pub. Date: May 29, 2014

(54) APPARATUS AND METHOD FOR RECEIVING SATELLITE BROADCAST

(71) Applicant: ELECTRONICS AND TELECOMMUNICATIONS RESEARCH INSTITUTE, Daejeon (KR)

(72) Inventors: Joon Gyu RYU, Daejeon (KR); Jun Gil JEON, Gyeonggi-do (KR); Min Su SHIN, Daejeon (KR); Deock Gil OH, Daejeon (KR)

(21) Appl. No.: 13/909,439

(22) Filed: Jun. 4, 2013

(30) Foreign Application Priority Data
Nov. 28, 2012 (KR) 10-2012-0136198

(51) Int. Cl. H04N 21/44; H04N 21/438; H04N 21/442

(52) U.S. Cl. CPC H04N 21/44; H04N 21/44209; H04N 21/4382
USPC 725/70

(57) ABSTRACT

Provided is an apparatus and a method for receiving a satellite broadcast. The method may include estimating a channel using signal-to-noise ratio (SNR) information being received, determining a video signal to be received among at least two video signals based on the estimated channel, and controlling selective reception of the determined video signal.

### CROSS-REFERENCE TO RELATED APPLICATION

This application claims the priority benefit of Korean Patent Application No. 10-2012-0136198, filed on Nov. 28, 2012, in the Korean Intellectual Property Office, the disclosure of which is incorporated herein by reference.

### BACKGROUND

1. Field of the Invention

Exemplary embodiments relate to an apparatus and method for receiving a satellite broadcast.

2. Description of the Related Art

To provide high definition satellite broadcasts in a Ka-band in which rain attenuation is severe, a scalable video coding (SVC)-based satellite broadcasting transmission technology and a simulcast satellite broadcasting transmission technology, may be used, by way of example.

Generally, the SVC based technology enables the hierarchical encoding of a high-quality video, for example, a high definition (HD) video or an ultra high definition (UD) video, and transmission of the video using different modulation and coding (MODCOD) schemes.

According to an SVC-based satellite broadcasting transmission technology, a UD video to be transmitted may be encoded by an SVC encoder in a base layer and an enhancement layer to allow a receiver to receive the UD video in an HD format as well as a UD format.

The UD video may be received through a base layer and an enhancement layer under a clear sky condition, and may be received only through a base layer under a rainy condition. However, implementing the SVC-based satellite broadcasting transmission technology in an existing receiver is impossible.

### SUMMARY

According to an aspect of the present invention, there is provided an apparatus for receiving a satellite broadcast including a receiving unit to receive signal-to-noise ratio (SNR) information, a video determining unit to estimate a channel using the SNR information, and to determine a video signal to be received among at least two video signals based on the estimated channel, and a video selecting unit to control selective reception of the determined video signal.

The video determining unit may estimate the channel using an adaptive filter.

The video determining unit may estimate the channel using a gradient algorithm.

The at least two video signals may include a high definition (HD) video signal, a ultra-high definition (UD) video signal, and a standard definition (SD) video signal.

The video determining unit may determine the video signal to be received in a same video receiving interval, using hysteresis.

The video determining unit may determine the video signal to be received, based on an external environmental factor.

The video determining unit may determine, under a clear sky condition, a highest definition video signal among the at least two video signals to be the video signal to be received.

The at least two video signals may be transmitted concurrently from a video transmission system.

The receiving unit may receive an HD video signal being modulated using variable coding and modulation (VCM) in quadrature phase shift keying (QPSK) by the video transmission system.

The receiving unit may receive a UD video signal being modulated using VCM in 8PSK by the video transmission system.

According to another aspect of the present invention, there is provided a method of receiving a satellite broadcast including receiving SNR information, estimating a channel using the SNR information, determining a video signal to be received among at least two video signals based on the estimated channel, and controlling selective reception of the determined video signal.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a satellite broadcasting system according to an exemplary embodiment;

FIG. 2 illustrates a video transmission system according to an exemplary embodiment;

FIG. 3 illustrates a satellite broadcast receiving apparatus according to an exemplary embodiment;

FIG. 4 illustrates an example of a video being received by a satellite broadcast receiving apparatus under a clear sky condition;

FIG. 5 illustrates an example of a video being received by a satellite broadcast receiving apparatus under a rainy condition; and

FIG. 6 is a flowchart illustrating a method of receiving a satellite broadcast according to an exemplary embodiment.

### DETAILED DESCRIPTION

Reference will now be made in detail to exemplary embodiments of the present invention, examples of which are illustrated in the accompanying drawings.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein. Like reference numerals refer to the like elements throughout.

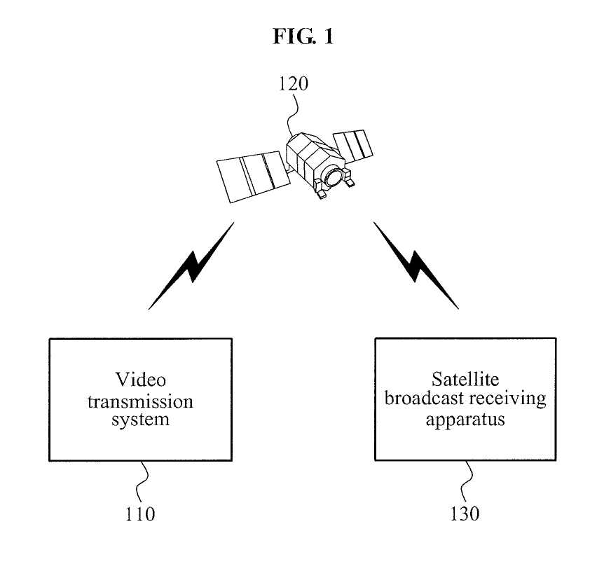

FIG. 1 illustrates a satellite broadcasting system according to an exemplary embodiment.

Referring to FIG. 1, a video transmission system 110 according to an exemplary embodiment may transmit a video signal to a satellite broadcast receiving apparatus 130 through a satellite transponder 120 using a simulcast satellite broadcasting transmission technique. Here, the satellite broadcasting system 110 may transmit at least two video signals concurrently to the satellite broadcast receiving apparatus 130.

For example, the video transmission system 110 may transmit various satellite broadcasting signals, for example, a TV broadcasting signal and a pulse code modulation (PCM) broadcasting signal, to the satellite broadcast receiving apparatus 130 through the satellite transponder 120 of a broadcast satellite orbiting at about 35,784 km above the Earth.

The video transmission system 110 may employ a broadcast mechanism for transmitting or re-transmitting a signal from a space station mounted in an artificial satellite to allow the public to receive broadcasts directly. Here, broadcasts may be classified into high level output and intermediate level output based on a type of broadcast reception of a receiver, for example, private reception and public reception. Generally, satellite broadcasts intended for private reception are being used worldwide, and satellite broadcasts of an intermediate level output are also provided for the purpose of distribution to a cable TV (CATV) intended for public reception.

Due to direct wave transmission from a satellite, the video transmission system 110 may prevent video quality deterioration, and may allow nationwide simulcast broadcasts and high quality video reception in a fringe area.

The video transmission system 110 may allow high-quality broadcasts using a PCM device, and since a satellite is used as a relay broadcast medium, the video transmission system 110 may provide broadcasts nationwide via simulcast even in emergency situations on a global basis, for example, natural disasters or war.

Hereinafter, the video transmission system 110 is described in further detail.

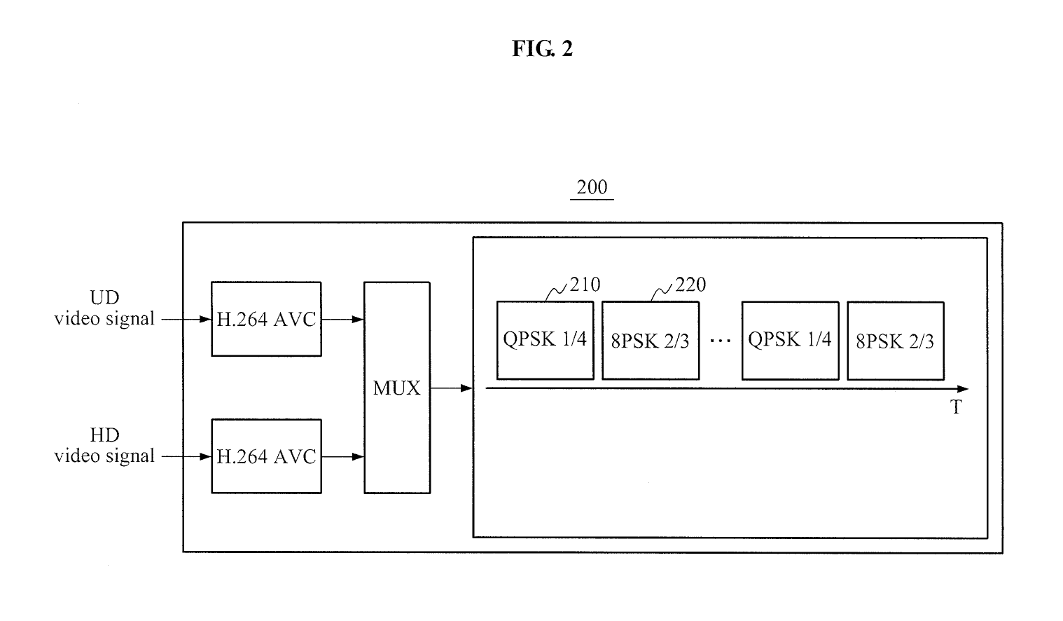

FIG. 2 illustrates a video transmission system 200 according to an exemplary embodiment.

Referring to FIG. 2, the video transmission system 200 may transmit at least two video signals to a satellite broadcast receiving apparatus via simulcast.

The term “simulcast” as used herein may correspond to, in a broadcast communication technology, a video transmission mechanism for transmitting various types of video signals to a broadcast receiving apparatus.

For example, simulcast may refer to a video transmission architecture for displaying a UDTV program or an HDTV program through a general video player. A general TV is incompatible with an HDTV signal and is incapable of displaying an HDTV program. However, simulcast may enable the transmission of an HDTV program as an HD video signal and a general video signal through different channels concurrently to display an HDTV program through a general TV.

According to an exemplary embodiment, the video transmission system 200 may modulate an HD video signal using variable coding and modulation (VCM) in quadrature phase shift keying (QPSK) 210 and may modulate a UD video signal using VCM in 8PSK 220, and may transmit each of the modulated video signals to the satellite broadcast receiving apparatus.

The video transmission system 200 may use VCM and H.264SVC schemes concurrently, and may packetize and multiplex a SVC stream along with an audio stream, may divide into a base layer packet stream and an enhancement layer packet stream, and may input the packet streams to a digital video broadcasting-Satellite-Second Generation (DVB-S2) system through separate ports.

The VCM scheme may include data transmission with a fixed length of a physical layer frame (PLFRAME) using the same modulation scheme and a variable coding rate, and data transmission with a variable length of a PLFRAME using a variable modulation scheme and a variable coding rate, or using a variable modulation scheme. The VCM scheme using the same modulation scheme and the variable coding rate may facilitate the frame synchronization. Accordingly, data may be output at a coding rate extracted from a PLFRAM header.

The VCM scheme may involve identifying a modulation scheme for each frame due to different modulation schemes from frame to frame, and may execute a frame synchronization strategy based on a frame transmission sequence known to a transmitter and a receiver. For example, the VCM scheme may improve the probability of frame synchronization by executing frame synchronization using known information that QPSK ¼ 210 and 8PSK ⅔ 220 are transmitted iteratively or periodically, as shown in FIG. 2.

According to an exemplary embodiment, the satellite broadcast receiving apparatus may receive different types of videos based on a channel environment, for example, an HD video under a rainy condition and a UD video under a clear sky condition.

Hereinafter, the satellite broadcast receiving apparatus according to an exemplary embodiment is described in further detail.

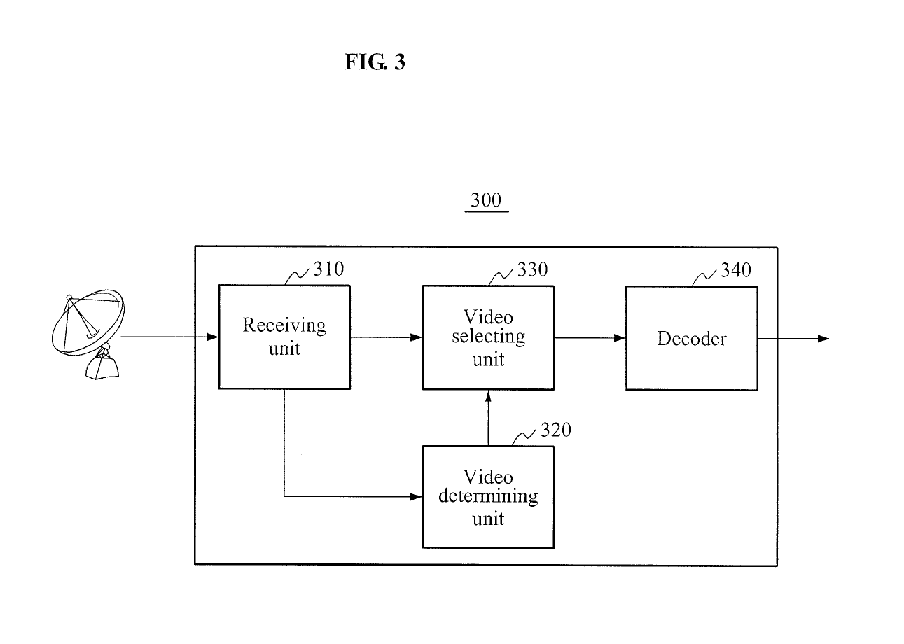

FIG. 3 illustrates a satellite broadcast receiving apparatus 300 according to an exemplary embodiment.

Referring to FIG. 3, the satellite broadcast receiving apparatus 300 according to an exemplary embodiment may include a receiving unit 310, a video determining unit 320, and a video selecting unit 330.

The receiving unit 310 may receive signal-to-noise ratio (SNR) information.

The video determining unit 320 may estimate a channel using the SNR information, and may determine a video signal to be received among at least two video signals based on the estimated channel.

The video selecting unit 330 may control selective reception of the determined video signal.

Here, the at least two video signals may include an HD video signal, a UD video signal, and a standard definition (SD) video signal, but is not limited to a specific type of signal and may include various types of satellite signals being transmitted from a video transmission system.

The satellite broadcast receiving apparatus 300 may further include a decoder 340 to decode and output the received video signal.

The satellite broadcast receiving apparatus 300 may estimate a channel in time T (seconds) using SNR information received through the receiving unit 310, and may select one video signal among a UD video signal and an HD video signal based on the estimated SNR value.

According to an exemplary embodiment, the video determining unit 320 may estimate the channel using an adaptive filter. The video determining unit 320 may estimate the channel using a gradient algorithm.

The video determining unit 320 may determine a video signal to be received in the same video receiving interval using hysteresis. The video determining unit 320 may determine the video signal to be received, based on an external environmental factor.

For example, the satellite broadcast receiving apparatus 300 may oscillate a channel by changing an SNR value quickly based on a channel environment, and when a video is present in the same video receiving interval for N seconds, may select such a video to be a video to be received using hysteresis, so that an error in estimation may be reduced.

According to an exemplary embodiment, at least two video signals may be transmitted concurrently from a video transmission system.

The receiving unit 310 may receive an HD video signal being modulated using VCM in QPSK by the video transmission system, and may receive a UD video signal being modulated using VCM in 8PSK by the video transmission system.

The video determining unit 320 may determine, under a clear sky condition, a highest definition video signal among the at least two video signals to be a video signal to be received.

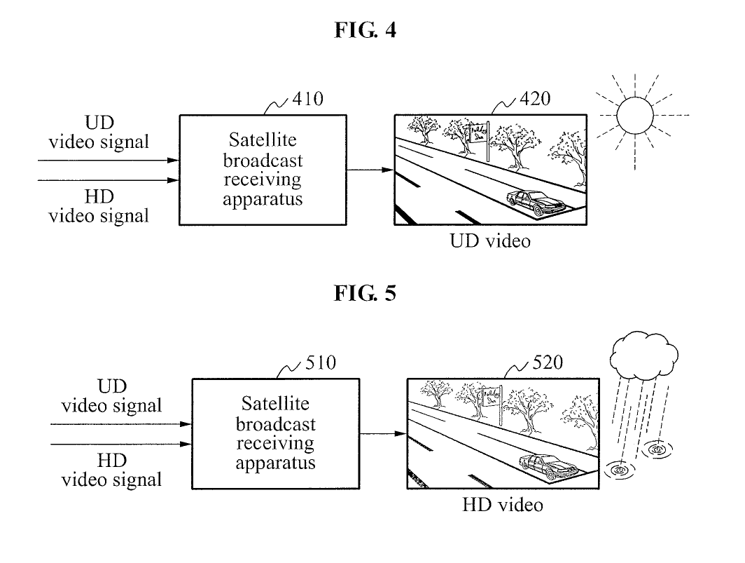

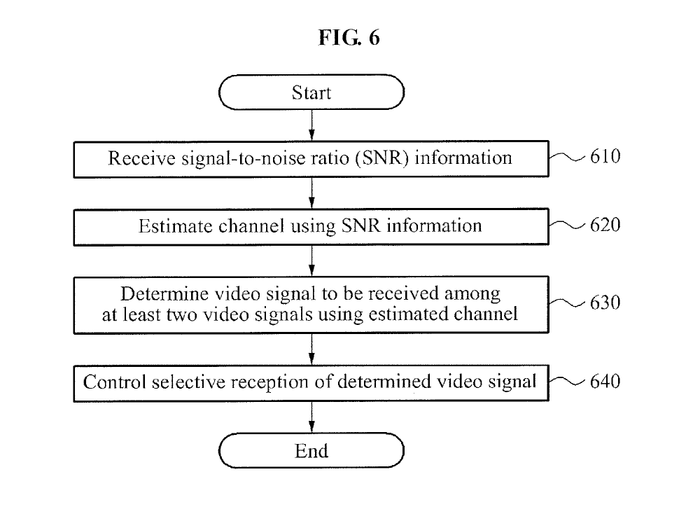

FIG. 4 illustrates an example of a video being received by a satellite broadcast receiving apparatus 410 under a clear sky condition, and FIG. 5 illustrates an example of a video being received by a satellite broadcast receiving apparatus 510 under a clear sky condition.

Referring to FIG. 4, the satellite broadcast receiving apparatus 410 may determine, under a clear sky condition, a UD video signal 420 to be a video signal to be received using a video determining unit. The satellite broadcast receiving apparatus 410 may receive the determined UD video signal 420 selectively, and may decode and output the UD video signal 420.

Referring to FIG. 5, the satellite broadcast receiving apparatus 510 may determine, under a rainy condition, an HD video signal 520 to be a video signal to be received using a video determining unit. The satellite broadcast receiving apparatus 510 may receive the determined HD video signal 520 selectively, and may decode and output the HD video signal 520.

Hereinafter, a method of receiving a satellite broadcast according to an exemplary embodiment is described in detail.

FIG. 6 is a flowchart illustrating a method of receiving a satellite broadcast according to an exemplary embodiment.

Referring to FIG. 6, in operation 610, the satellite broadcast receiving apparatus may receive SNR information.

In operation 620, the satellite broadcast receiving apparatus may estimate a channel using the SNR information.

In operation 630, the satellite broadcast receiving apparatus may determine a video signal to be received among at least two video signals based on the estimated channel.

Here, the at least two video signals may include video signals having different definitions, for example, an HD video signal, a UD video signal, and an SD video signal.

According to an exemplary embodiment, the satellite broadcast receiving apparatus may receive video signals having different definitions concurrently, and may determine a signal to be output finally based on the channel estimated using the SNR information.

Here, the satellite broadcast receiving apparatus may estimate the channel using an adaptive filter or a gradient algorithm. The satellite broadcast receiving apparatus may determine a video signal to be received in the same video receiving interval, using hysteresis.

For example, the satellite broadcast receiving apparatus may update a step size of the adaptive filter adaptively based on a differentiated value of a cost function, and may estimate the channel using a channel coefficient of the adaptive filter of the updated step size.

Also, the satellite broadcast receiving apparatus may determine the video signal to be received, based on an external environmental factor. For example, the satellite broadcast receiving apparatus may determine, under a clear sky condition, a highest definition video signal among the at least two video signals to be a video signal to be received.

In operation 640, the satellite broadcast receiving apparatus may control selective reception of the determined video signal.

For example, the satellite broadcast receiving apparatus may determine, under a clear sky condition, a UD video signal to be a video signal to be received, may receive the determined UD video signal selectively, and may decode and output the UD video signal.

The satellite broadcast receiving apparatus may determine, under a rainy condition, an HD video signal to be a video signal to be received, may receive the determined HD video signal selectively, and may decode and output the HD video signal.

According to an exemplary embodiment, the apparatus and method for receiving a satellite broadcast may improve availability through estimation of rain attenuation in a VCM-based satellite broadcast.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard discs, floppy discs, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for receiving a satellite broadcast, the apparatus comprising:
a receiving unit to receive signal-to-noise ratio (SNR) information;
a video determining unit to estimate a channel using the SNR information, and to determine a video signal to be received among at least two video signals based on the estimated channel; and
a video selecting unit to control selective reception of the determined video signal.

2. The apparatus of claim 1, wherein the video determining unit estimates the channel using an adaptive filter.

3. The apparatus of claim 1, wherein the video determining unit estimates the channel using a gradient algorithm.

4. The apparatus of claim 1, wherein the at least two video signals include a high definition (HD) video signal, a ultra-high definition (UD) video signal, and a standard definition (SD) video signal.

5. The apparatus of claim 1, wherein the video determining unit determines the video signal to be received in a same video receiving interval, using hysteresis.

6. The apparatus of claim 1, wherein the video determining unit determines the video signal to be received, based on an external environmental factor.

7. The apparatus of claim 6, wherein the video determining unit determines, under a clear sky condition, a highest definition video signal among the at least two video signals to be the video signal to be received.

8. The apparatus of claim 1, wherein the at least two video signals are transmitted concurrently from a video transmission system.

9. The apparatus of claim 8, wherein the receiving unit receives an HD video signal being modulated using variable coding and modulation (VCM) in quadrature phase shift keying (QPSK) by the video transmission system.

10. The apparatus of claim 7, wherein the receiving unit receives a UD video signal being modulated using VCM in 8PSK by the video transmission system.

11. A method of receiving a satellite broadcast, the method comprising:
receiving signal-to-noise ratio (SNR) information;
estimating a channel using the SNR information;
determining a video signal to be received among at least two video signals based on the estimated channel; and
controlling selective reception of the determined video signal.

12. The method of claim 11, wherein the estimating of the channel comprises estimating the channel using an adaptive filter.

13. The method of claim 11, wherein the estimating of the channel comprises estimating the channel using a gradient algorithm.

14. The method of claim 11, wherein the at least two video signals include a high definition (HD) video signal, a ultra-high definition (UD) video signal, and a standard definition (SD) video signal.

15. The method of claim 11, wherein the determining of the video signal to be received comprises determining the video signal to be received in a same video receiving interval, using hysteresis.

16. The method of claim 11, wherein the determining of the video signal to be received comprises determining the video signal to be received, based on an external environmental factor.

17. The method of claim 16, wherein the determining of the video signal to be received comprises determining, under a clear sky condition, a highest definition video signal among the at least two video signals to be the video signal to be received.

18. The method of claim 11, wherein the at least two video signals are transmitted concurrently from a video transmission system.

19. The method of claim 18, further comprising:
receiving an HD video signal being modulated using variable coding and modulation (VCM) in quadrature phase shift keying (QPSK) by the video transmission system.

20. The method of claim 18, further comprising:
receiving a UD video signal being modulated using VCM in 8PSK by the video transmission system.
